(19) United States
(12) Patent Application Publication
(10) Pub. No.: US 2016/0353049 A1
(43) Pub. Date: Dec. 1, 2016

(54) Method and System for Displaying a Projected Path for a Machine

(71) Applicant: Caterpillar Inc., Peoria, IL (US)

(72) Inventor: Jacob Maley, Germantown Hills, IL (US)

(73) Assignee: Caterpillar Inc., Peoria, IL (US)

(21) Appl. No.: 14/722,535

(22) Filed: May 27, 2015

(51) Int. Cl. H04N 5/445; H04N 5/247; B60R 11/04; G06K 9/46; G06K 9/62; B60R 1/00; H04N 5/232

(52) U.S. Cl. CPC H04N 5/44504; B60R 1/00; H04N 5/247; H04N 5/23238; G06K 9/46; G06K 9/6202; B60R 11/04; B60R 2300/8086; B60R 2300/802; B60R 2300/207

(57) ABSTRACT

Systems and methods for displaying a projected path of a machine using image data of the ground engaging members of the machine. One method includes receiving one or more images; displaying on a display device a first image of the one or more images; determining one or more ground engaging members of the machine in the one or more images; determining a current state of each of the one or more ground engaging members using at least information regarding the one or more ground engaging members contained in the one or more images; determining a projected path of the machine based on at least the current state of each of the one or more ground engaging members; and displaying on the display device a graphic corresponding to the projected path of the machine overlaying the first image.

### TECHNICAL FIELD

This patent disclosure relates generally to displaying a projected path of a machine and, more particularly, to displaying a projected path of a machine using image data of ground engaging members of the machine.

### BACKGROUND

Machines including, for example, haulers, excavators, and other heavy machinery are commonly used at work sites. Due to the nature of worksites, their surfaces are often obstructed by a variety of obstacles such as, for example, equipment, vehicles, workers, building infrastructure, and other objects. In order to prevent damage to machines, it is important for operators of those machines to avoid colliding with such obstacles. This may be difficult, however, depending on a number of factors. For example, the size and design of a machine may provide poor visibility of the surroundings of the machine to the operator. Certain machines also may be remotely or autonomously controlled, making it more difficult for the remote operator to identify obstacles within the path of travel of the machine.

One way to reduce the risk of collisions with obstacles is to provide operators with a display of the path of travel of the machine. U.S. Pat. No. 8,063,752 B2 to Oleg (“the '752 patent”) discloses a method of anticipating a path of travel of a vehicle using steering angle data and displaying the path of the vehicle to an operator. More specifically, the '752 patent describes a camera unit that is capable of detecting a variation of a steering angle of the vehicle and performing calculations based on that variation to generate an overlay path for the vehicle. The camera unit is attached to the rear or front part of the vehicle. The camera unit incorporates an optical system with a field of view covering a certain area behind or in front of the vehicle. The camera unit also incorporates an interface transceiver that acquires and sends descriptors of the steering angle to an interface controller. The interface controller incorporates a microprocessor that calculates the values of one or more nodes using a set of parameters and mathematical equations. In particular, a set of parameters for each value of a steering angle descriptor is stored in the memory of the interface controller. According to the steering angle descriptor acquired by the interface transceiver, the interface controller selects a set of parameters and calculates the nodes. After the nodes are calculated, an image processing device also incorporated in the camera unit generates driving corridor markers using the nodes calculated by the interface controller. The camera unit then superimposes the driving corridor markers on the field of view captured by the optical system, and the resulting image is transmitted to a monitor to be displayed to the operator of the vehicle.

Although the system described in the '752 patent is capable of providing a path of travel of a vehicle, it is not equipped to do so without the use of steering angle data. Modern machines may have steering sensors, which can detect steering adjustments made by an operator and provide that information for path prediction purposes. Many older machines, however, do not have this sensor available. Moreover, while the system described in the '752 patent may project a path of travel for a vehicle, it does not have a way for testing the accuracy of the projected path. These and other shortcomings of the prior art are addressed by this disclosure.

### SUMMARY

This disclosure relates to systems and methods for displaying a projected path of a machine using image data of ground engaging members of the machine. In an aspect, a method may include receiving one or more images from one or more image capture devices, the one or more image capture devices disposed on the machine; displaying on a display device a first image of the one or more images; determining one or more ground engaging members of the machine in the one or more images; determining a current state of each of the one or more ground engaging members using at least information regarding the one or more ground engaging members contained in the one or more images; determining a first projected path of the machine based on the current state of each of the one or more ground engaging members; and displaying on the display device a graphic corresponding to the first projected path of the machine, the graphic displayed overlaying the first image.

In an aspect, a method may include receiving from a first image capture device a landscape image; displaying on a display device the landscape image; receiving one or more localized images from one or more additional image capture devices, each of the one or more localized images depicting a section of one or more ground engaging members of the machine; determining one or more portions of the one or more localized images that correspond to the one or more ground engaging members; analyzing the one or more portions to determine a current state of each of the one or more ground engaging members; determining a first projected path of the machine based on at least the current state of each of the one or more ground engaging members; and displaying on the display device a graphic corresponding to the first projected path of the machine, the graphic displayed overlaying the landscape image.

In an aspect, a system may include a processor and a memory bearing instructions that, upon execution by the processor, cause the processor to: receive one or more images from one or more image capture devices, the one or more image capture devices disposed on the machine; display on a display device a first image of the one or more images; determine one or more ground engaging members of the machine in the one or more images; determine a current state of each of the one or more ground engaging members using at least information regarding the one or more ground engaging members contained in the one or more images; determine a first projected path of the machine based on at least the current state of each of the one or more ground engaging members; and display on the display device a graphic corresponding to the first projected path of the machine, the graphic displayed overlaying the first image.

### BRIEF DESCRIPTION OF THE DRAWINGS

FIG. 1 depicts a top view of an exemplary machine including one or more image capturing devices in accordance with aspects of the disclosure.

FIG. 2 is a block diagram of an exemplary system for displaying a path of travel of a machine in accordance with aspects of the disclosure.

FIG. 3 depicts an exemplary field of view of an image capturing device including a ground engaging member in a first state in accordance with aspects of the disclosure.

FIG. 4 depicts an exemplary field of view of an image capturing device including a ground engaging member in a second state in accordance with aspects of the disclosure.

FIG. 5 depicts an exemplary field of view of an image capturing device including a ground engaging member in a third state in accordance with aspects of the disclosure.

FIG. 6 depicts an exemplary display of a path of travel of a machine in accordance with aspects of the disclosure.

FIG. 7 depicts another exemplary display of a path of travel of a machine in accordance with aspects of the disclosure.

FIG. 8 is a flow diagram illustrating an exemplary method for displaying a path of travel of a machine in accordance with aspects of the disclosure.

FIG. 9 is a flow diagram illustrating another exemplary method for displaying a path of travel of a machine in accordance with aspects of the disclosure.

FIG. 10 is a block diagram of an exemplary computer system configured to implement methods for displaying a path of travel of a machine in accordance with aspects of the disclosure.

### DETAILED DESCRIPTION

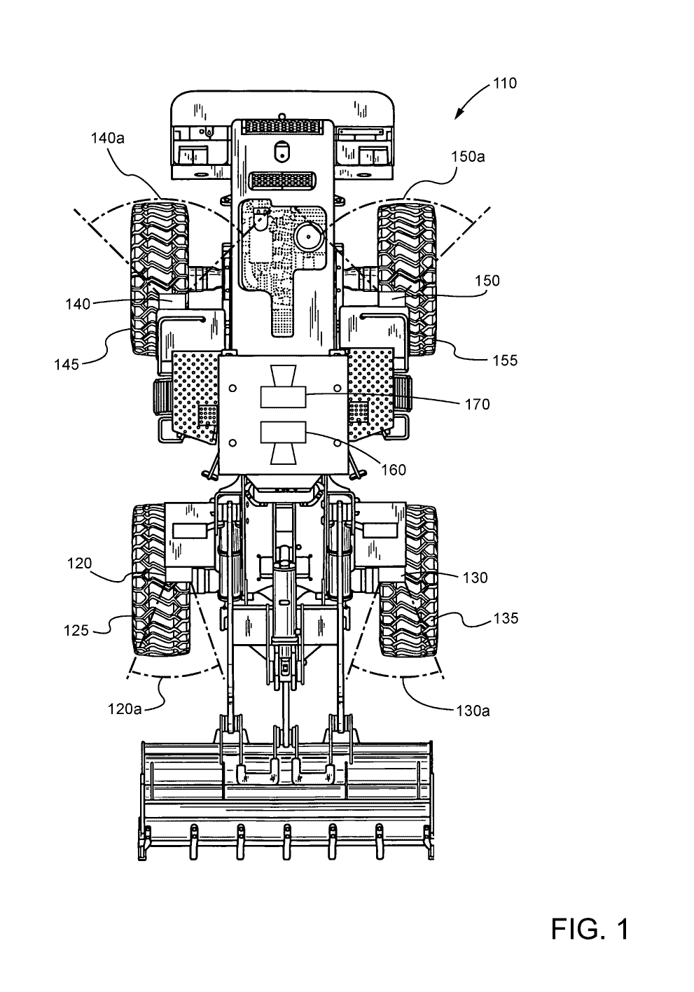

Embodiments of the present invention, and their features and advantages, may be understood by referring to FIGS. 1-10, like numerals being used for corresponding parts in the various drawings.

The present disclosure provides systems and methods for displaying a projected path of a machine using image data of ground engaging members (e.g., wheels, crawlers, chaise) of the machine. In systems and methods described herein, the image data of the ground engaging members of the machine may be collected by cameras. The cameras may be mounted on the machine in a location near the ground engaging members of the machine. Each camera may have a field of view including a section of a ground engaging member and its surrounding ground terrain. As the machine is moving, the cameras may capture and provide a stream of images of the ground engaging members to an onboard or remote processor. The processor may use conventional image processing tools to extract information regarding the ground engaging members from the images. For example, the processor may filter the images to remove the background terrain. Then, from analyzing the remaining portion of the images including the ground engaging members, the processor may determine the current states or positions of each ground engaging member. The current state of a ground engaging member may be the degree that it is turned or rotated from a reference axis. For instance, assuming that the reference axis runs parallel to the front-to-rear axis of the machine, if a ground engaging member is facing forward, then its current state would be V If the ground engaging member is rotated to the left or right, then its current state would be the angle at which its center axis is offset from the reference axis.

The processor may determine the current states of the ground engaging members by analyzing the orientation of physical markers on the ground engaging members. Physical markers on a ground engaging member may include a paint marker, a tread pattern, or other visible feature associated with the ground engaging member. To provide an example, a ground engaging member such as a wheel may have a tread line that runs parallel to its sides. The processor may identify the tread line and, knowing that the tread line runs parallel to the sides of the wheel, determine whether the wheel is facing forward or rotated at an angle. The processor may also determine the current states of the ground engaging members by comparing the images of the ground engaging members captured by the cameras to a pre-stored set of images, each of which depicts the ground engaging members in a different state. Then, by identifying a match between the images captured by the cameras and one of the pre-stored images, the processor may determine the current state of a ground engaging member.

The processor may calculate a projected path of travel for the machine using the determined states of the ground engaging members along with additional information about the ground engaging members, the properties of the images captured by the cameras, and the machine. Such additional information may include physical properties of the ground engaging members that may affect is path of travel (e.g., traction properties, contact patch, load sensitivity) and any distortions present in the images due to the position of the cameras and their lens. Such information may also include information about the machine such as axial length or wheel-based length, ground engaging member size or tract size, type of ground engaging member, etc. The projected path of travel may be displayed overlaying an image of the area surrounding the machine in its direction of travel. A camera mounted in the front or rear of the machine may be used to capture an image of the area surrounding the machine in its direction of travel. The camera may incorporate a wide-angle lens in order to maximize the surrounding area that it captures. Because wide-angle lens cameras typically distort the horizontal or vertical perspectives of an image, the processor may also take into account any distortions caused by this camera in calculating the projected path of travel of the machine.

According to an aspect of the disclosure, the projected path of travel of the machine may be updated in real-time as the current state of the ground engaging members of the machine change.

Now referring to FIG. 1, there is illustrated a machine 110. The machine can be an over-the-road vehicle such as a truck used in transportation or may be any other type of machine that performs some type of operation associated with an industry such as mining, construction, farming, transportation, or any other industry known in the art. For example, the machine may be an off-highway truck, an earth-moving machine, a wheel loader, an excavator, a dump truck, a backhoe, a motor grader, a material handler or the like. The specific machine illustrated in FIG. 1 is a wheel loader.

The machine 110 may include one or more ground engaging members 125, 135, 145, 155. The ground engaging members 125, 135, 145, 155 may form a part of a ground propulsion system for the machine 110. Examples of ground engaging members 125, 135, 145, 155 include a wheel with a tire mounted thereon and a continuous track system.

The machine 110 may be adapted according to the systems and methods disclosed herein. Specifically, the machine 100 may include one or more image capture devices 120, 130, 140, 150, 160, 170. The image capture devices 120, 130, 140, 150, 160, 170 may be digital cameras, video recorders, or other types of optical instruments that records images that can be stored directly or transmitted to another location. While the machine 110 is shown having six image capture devices 120, 130, 140, 150, 160, 170, those skilled in the art will appreciate that the machine 110 may include any number of image capture devices arranged in any manner capable of accomplishing the methods disclosed herein.

The image capture devices 120, 130, 140, 150, 160, 170 may be included on the machine 110 during operation of the machine 110, for example, as the machine 110 moves about an area to complete certain tasks such as digging, loosening, carrying, drilling, or compacting different materials.

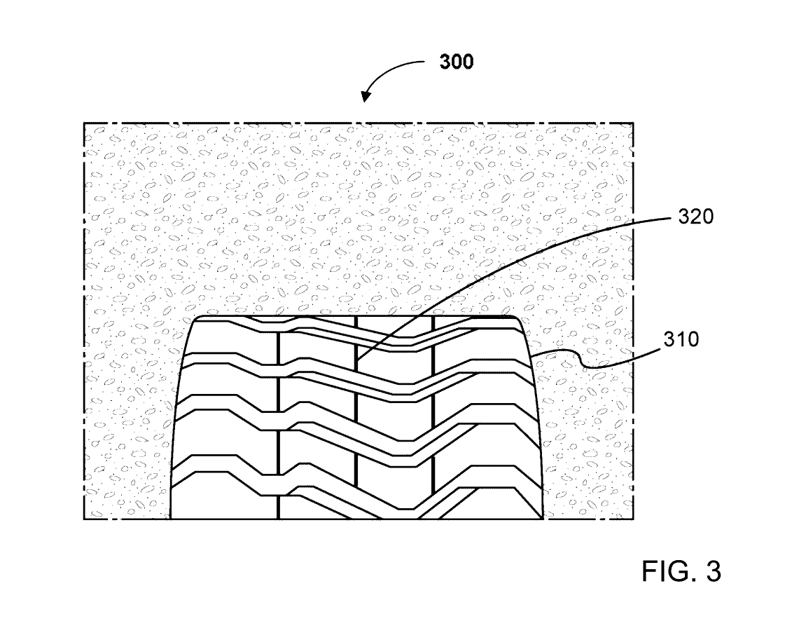

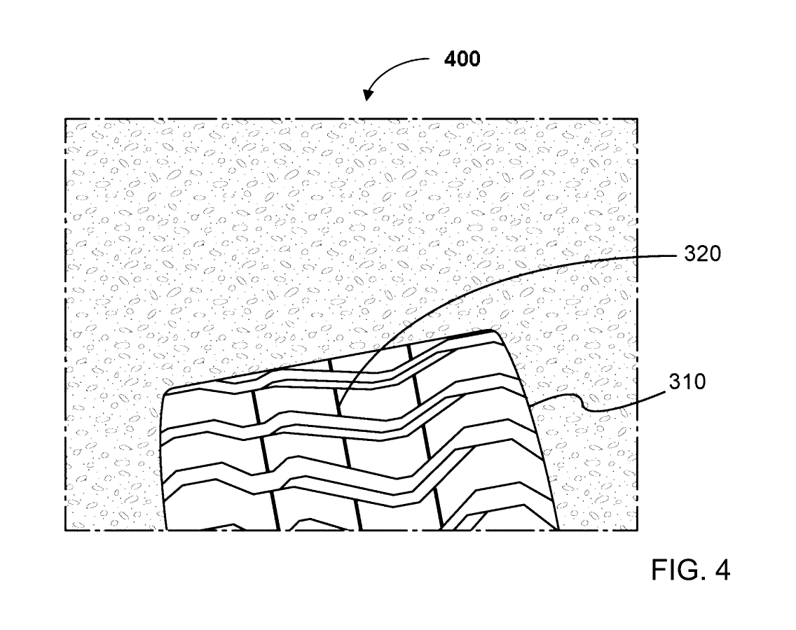

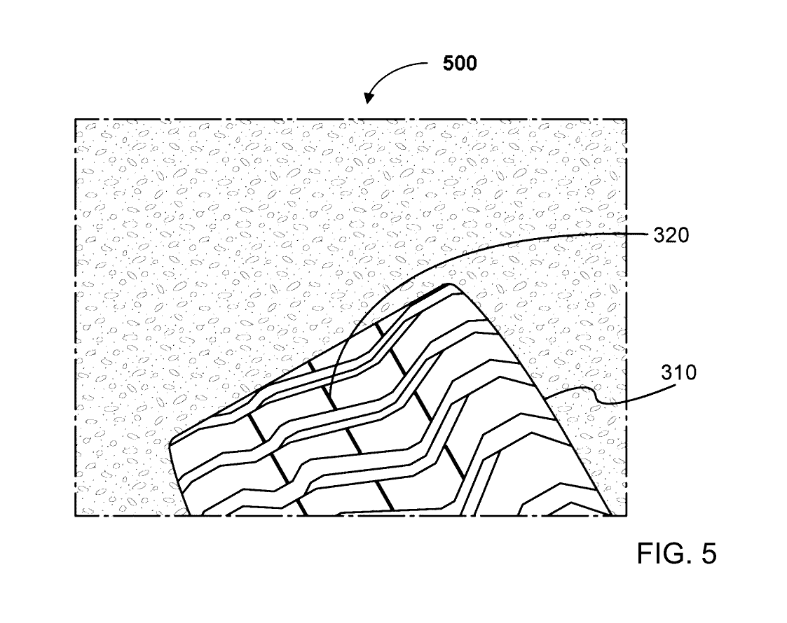

The image capture devices 120, 130, 140, 150 may capture images of areas surrounding the machine 110 in their respective fields of view 120a, 130a, 140a, 150a. In particular, the image capture devices 120, 130, 140, 150 may capture images including a ground engaging member and an area surrounding that ground engaging member. For example, the image capture device 120 may capture images including the ground engaging member 125 and an area such as the terrain surrounding the ground engaging member 125. FIGS. 3, 4, and 5 are images captured by an image capturing device including a section of a ground engaging member 310 and its surrounding terrain. FIG. 3 depicts an image 300, FIG. 4 depicts an image 400, and FIG. 5 depicts an image 500. The ground engaging member 310 in FIGS. 3, 4, and 5 may correspond to one of the ground engaging members 125, 135, 145, 155.

The fields of view 120a, 130a, 140a, 150a may be the same or vary depending on the specifications of the image capture devices 120, 130, 140, 150. For instance, as depicted in FIG. 1, the field of view 120a is smaller than the field of view 140a. This difference may be due to different lens used by the image capture device 120 and the image capture device 140. The images captured by the image capture devices 120, 130, 140, 150 may be used by one or more processors—for example, a computing device 250, which is described in further detail below—to determine a current state of one or more of the ground engaging members 125, 135, 145, 155.

The current state of a ground engaging member is a representation of the particular way in which the ground engaging member is placed or positioned. The current state of a ground engaging member may be represented as a displacement from a specific position (e.g., a reference position). With respect to ground engaging members that are rotated about an axis, the current state of a ground engaging member may be the angle at which the ground engaging member is turned or rotated from the specific position. To provide an example, FIGS. 3, 4, and 5 depict the ground engaging member 310 in three different states. In FIG. 3, the ground engaging member 310 is orientated straight, and in FIGS. 4 and 5, the ground engaging member 310 is orientated at an angle. If the state of the ground engaging member 310 in FIG. 3 is taken as the reference position, then the state the ground engaging member 310 in FIG. 3 may be represented as 0° and the states of the ground engaging member 310 in FIGS. 4 and 5 may be represented as an angular displacement from the position of the ground engaging member 310 in FIG. 3. Given the smaller angular displacement of the ground engaging member 310 in FIG. 4 as compared to FIG. 5, the state of the ground engaging member 310 in FIG. 4 may be represented by a smaller angular value than the state of the ground engaging member 310 in FIG. 5.

The image capture devices 160, 170 may capture a view of the landscape in a direction of travel of the machine 110 (e.g., a landscape image). To maximize the area captured by the image capture devices 160, 170, the image capture devices 160, 170 may incorporate lenses with a wide field of view, for example, 180-185°. The image capture device 160 may capture an area to the front of the machine 110. The image capture device 160 may be attached to the machine 110 at a position that enables it to capture a large area to the front of the machine 110. As shown in FIG. 1, the image capture device 160 is attached to the top of the machine 110 facing forward. In an alternative embodiment, the image capture device 160 may also be attached closer to the front of the machine 110 as long as its position enables it to capture an area to the front of the machine 110. The image capture device 170 may capture an area to the rear of the machine 110. The image capture device 170 may be attached to the machine 110 at a position that enables it to capture a large area to the rear of the machine 110. As shown in FIG. 1, the image capture device 170 is attached to the top of the machine 110 facing rearwards. In an alternative embodiment, the image capture device 170 may also be attached closer to the back of the machine 110 as long as its position enables it to capture an area to the back of the machine 110.

During operation of the machine 110, the images captured by the image capture devices 160, 170 may be displayed to an operator to provide the operator with a sense of the landscape or environment around the machine 110.

According to an aspect of the disclosure, the image capture devices 160, 170 may capture images including one or more ground engaging members 125, 135, 145, 155. For example, the image capture device 160 may capture images including a portion of the ground engaging members 125, 135. One or more processors may then use the images captured by image capture device 160 to determine the current states of the ground engaging members 125, 135, and the image capture devices 120, 130 may not be needed.

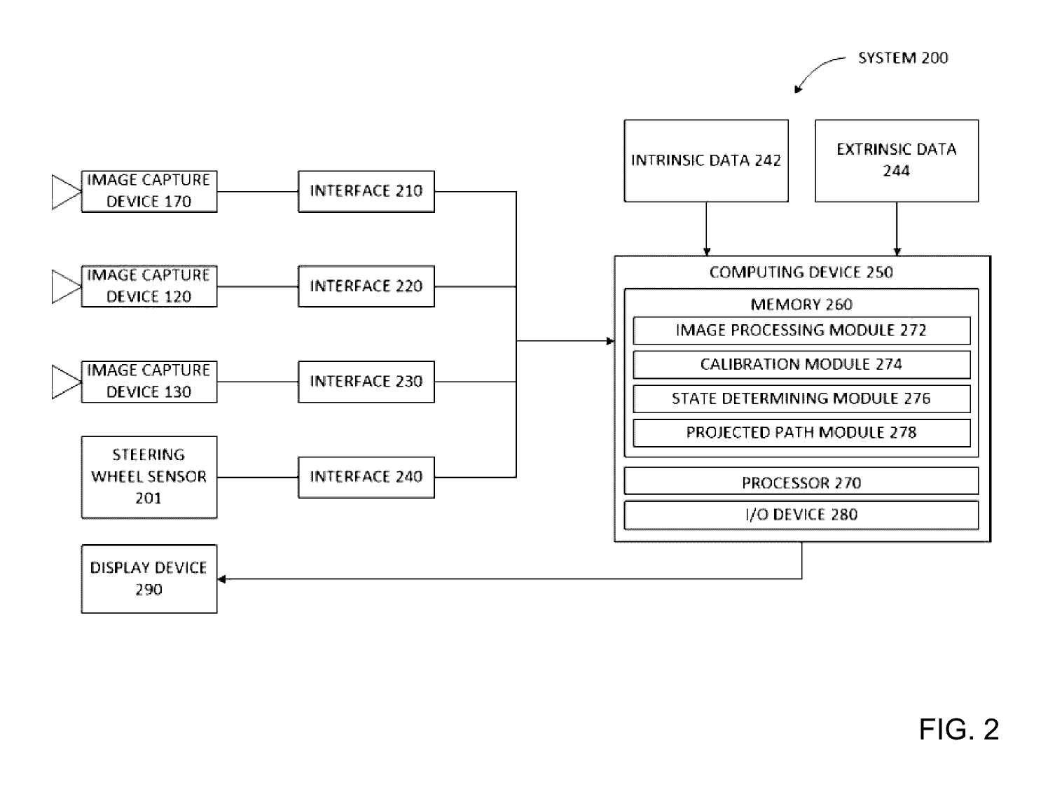

The machine 110 may also include a steering wheel (not shown) and a steering wheel sensor 201 (see FIG. 2). The steering wheel sensor 201 may be located proximate to the steering wheel of the machine 110—for example, the steering wheel sensor 201 can be disposed in a region of the steering spindle of the machine 110. The steering wheel sensor 201 is configured to detect an angular position of the steering wheel. The steering wheel sensor 201 may determine the angular position of the steering wheel using one or more light sources and light sensors. The machine 110 further includes a display device 290 (see FIG. 2). The display device 290 is configured to display, among other things, a projected path of travel of the machine 110. The display device 290 may be any type of visual display that provides a graphical user interface (GUI) to display information to operators and other users of the worksite.

FIG. 2 is a block diagram illustrating an exemplary system 200 that may be installed on the machine 110 or in communication with the machine 110 to display a projected path of travel of the machine 110. While FIG. 2 shows components of the system 200 as separate blocks, those skilled in the art will appreciate that the functionality described below with respect to one component may be performed by another component, or that the functionality of one component may be performed by two or more components. For example, the functionality of interface 210 may be performed by the computing device 250, or the functionality of processor 270 may be performed by two components.

The system 200 may include a computing device 250 configured to receive and analyze data (e.g., images captured by the image capture devices 120, 130, 140, 150, 160, 170) relating to the machine 110 and its ground engaging members 125, 135, 145, 155. The computing device 250 may include any type of device or a plurality of devices networked together including, for example, a desktop computer, personal computer, a laptop/mobile computer, a personal data assistant (PDA), a mobile phone, a tablet computer, cloud computing device, and the like, with wired/wireless communications capabilities via various communication channels. The computing device 250 may be located onboard or proximate to the machine 110 or may be located at a considerable distance remote from the machine 110, such as in a different city or even a different country. It is also contemplated that computers at different locations may be networked together to form the computing device 250, if desired.

The computing device 250 may include, among other things, a memory 260, a processor 270, and an input/output (I/O) device 280. The memory 260 may include any type of computer-readable medium, such as a memory device (e.g., random access, flash memory, and the like), an optical medium (e.g., a CD, DVD, BluRay®, and the like), firmware (e.g., an EPROM), or any other storage medium. The memory 260 stores computer-readable instructions that instruct computing device 250 to perform certain processes. In particular, the memory 260 stores modules including an image processing module 272, a calibration module 274, a state determining module 276, and a projected path module 278. In certain aspects, the modules may include logic embodied as hardware, firmware, or a collection of software written in a known programming language.

Data may be transferred to and from the computing device 250 via the I/O device 280. Specifically, the I/O device 280 may receive data from communication networks, data from other devices connected to the computing device 250, and input by an operator. The I/O device 280 may include, for example, network connections, data link connections, or antennas configured to receive wireless data and input devices such as a mouse, keyboard, or touchscreen configured to receive a manual input from an operator. The I/O device 280 also transmits or sends data over various communication channels and to other devices connected to the computing device 250. The data transferred to and from the computing device 250 by way of the I/O device 280 may include information regarding the machine 110, information regarding the ground engaging members 125, 135, 145, 155, information regarding the image capture devices 120, 130, 140, 150, 160, 170, and other intrinsic and extrinsic data (e.g., intrinsic data 242, extrinsic data 244). The other data may include, for example, weather data (current, historic, and forecast), machine maintenance and repair data, site data such as survey information or ground characteristics, and other data known in the art.

The system 200 may also include one or more image capture devices 120, 130, 170, the steering wheel sensor 201, and one or more sensor interfaces 210, 220, 230, 240. While only a subset of the image capture devices and a single steering wheel sensor are depicted in FIG. 2, those skilled in the art will appreciate that any number of image capture devices or other sensors may be included in the system 200, including others of the image capture devices 120, 130, 140, 150, 160, 170.

In certain aspects of the disclosure, before the computing device 250 may process images or other data captured by the one or more image capture devices 120, 130, 170 and the steering wheel sensor 201, the data must be converted to a format that is consumable by the computing device 250. Accordingly, the image capture device 170 may be connected to a sensor interface 210, and the image capture device 120 may be connected to a sensor interface 220, and so on and so forth. The sensor interfaces 210, 220, 230, 240 may receive signals from their respective devices and convert or package them into signals which may be processed by the computing device 250. For example, the sensor interface 210 may create digital image data using information it receives from the image capture device 170. The sensor interface 210 may also create metadata regarding the image capture device 170 and include it in a data structure or data package with the digital image data to send to the computing device 250. Such metadata may include intrinsic data of the image capture device 170 such as its make and model and any inherent characteristics (e.g., lens focal length) and data regarding the machine such axial length or wheel-based length, ground engaging member size or tract size, type of ground engaging member, etc. Such metadata may also include extrinsic data of the image capture device 170 such as its orientation and position and data regarding the machine (e.g., articulation angle).

In certain aspects of the disclosure, the sensor interfaces 210, 220, 230, 240 may expose an application program interface (API) that exposes one or more function calls allowing other components of system 200 (e.g., the computing device 250) to access the data received from the image capture devices 120, 130, 170 and the steering wheel sensor 201.

While the machine 110 is in operation, data may continuously flow from the image capture devices 120, 130, 170 and the steering wheel sensor 201 to the sensor interfaces 210, 220, 230, 240, which in turn may transmit that information to the computing device 250. Alternatively, the computing device 250 may access such data by retrieving it from the sensor interfaces 210, 220, 230, 240.

Using the image data corresponding to the images captured by the image capture devices 120, 130, 140, 150, 160, 170 mounted on the machine 110, the computing device 250 may predict and display a path of travel of the machine 110. The path of travel of the machine 110 may be displayed overlaying an image of an area surrounding the machine 110 in its direction of travel. Thus, depending on the direction of travel of the machine 110, data flowing from different image capture devices 120, 130, 140, 150, 160, 170 may be sent to (or retrieved by) the computing device 250. For instance, when the machine 110 is travelling in a rearwards direction, the computing device 250 may receive digital image data from the image capture device 170, which provides a rearwards view of the area surrounding the machine 110. Alternatively, when the machine 110 is travelling in a forwards direction, the computing device 250 may receive digital image data from the image capture device 160, which provides a front view of the area surrounding the machine 110.

As an illustrative example, when the machine 110 is travelling in a rearwards direction, the computing device 250 may receive digital image data corresponding to images captured by the image capture devices 120, 130, and 170. The image captured by the image capture device 170 may be a landscape image, which includes a view of the environment or landscape surrounding the back of the machine 110. The image captured by the image capture device 120, which is mounted above the ground engaging member 125, may be a more localized image that depicts a section of the ground engaging member 125 and its surrounding terrain. Similarly, the image captured by the image capture device 130, which is mounted above the ground engaging member 135, may be more a more localized image that depicts a section of the ground engaging member 135 and its surrounding terrain.

The processor 270 of the computing device 250, executing the image processing module 272, may process each of the images received from the image capture devices 120, 130 to remove the background (e.g., the surrounding terrain) of the images such that only the portions of the images including the ground engaging members 125, 135 remain. To remove the background, the processor 270 may employ conventional image processing techniques such as image segmentation, gradient detection, and filtering. For example, using gradient or edge detection techniques, each image may be segmented into multiple parts and the parts that correspond to the background may be removed before the image is reconstructed. The processor 270 may also adjust the size and placement of objects in the images to remove any distortions or warping that is associated with the make and model of the image capture devices used to capture the images. Furthermore, the processor 270, relying on information regarding the physical characteristics of the ground engaging members 125, 135 (e.g., the color or shape of the ground engaging members 125, 135), may use color and shape matching techniques to identify and extract the portions of the images that depict the ground engaging members 125, 135. The information regarding the physical characteristics of the ground engaging members 125, 135 may be pre-stored in the memory 260 of the computing device 250 or stored in a location that is accessible by the computing device 250.

The processor 270 of the computing device 250, executing the state determining module 276, may analyze the portions of the images captured by the image capture devices 120, 130 that depict the ground engaging members 125, 135 to determine a current state of each of the ground engaging members 125, 135. One method of performing the analysis and determining the current states of the ground engaging members 125, 135 involves comparing the portions to a set of reference portions to identify a reference portion that matches ones of the portions of the images captured by the image capture devices 120, 130. The set of reference portions may be from images that were previously taken of the ground engaging members 125, 135 during a calibration process, described in further detail below. Each of the reference portions is associated with a particular state of one of the ground engaging members 125, 135. Once a match is found between a reference portion and a portion of an image captured by the image capture devices 120, 130, the processor 270 may determine that the current state of the ground engaging member is the state of that ground engaging member that is associated with the reference portion.

A second method of performing the analysis to determine the current states of the ground engaging members 125, 135 involves using one or more features of a specific ground engaging member in the one or more portions of the images captured by image capture devices 120, 130. To provide an example, if a particular ground engaging member has tread marks, the processor 270 of the computing device 250 may identify a tread mark of the ground engaging member and use its orientation (e.g., configuration) to determine the current state of the ground engaging member. As depicted in FIGS. 3, 4, and 5, the ground engaging member 310 may comprise a tread mark 320. The orientation of the tread mark 320 may change as the state of the ground engaging member 310 changes. Specifically, as the state of the ground engaging member 310 displaces in an angular direction to the left (e.g., from FIG. 3 to FIG. 4), the tread mark 320 changes its orientation in a similar fashion. For each state of the ground engaging member 310, the orientation of the tread mark 320 would be different. For example, when the state of the ground engaging member 310 is that shown in FIG. 4, the orientation of the tread mark 320 may be angled to the left by 5°. Then, when the state of the ground engaging member 310 is that shown in FIG. 5, the orientation of the tread mark 320 may be angled to the left by 10°. Thus, by analyzing the tread mark 320 and determining its orientation, the processor 270 may be able to discern a current state of the ground engaging member 310.

Describing now the calibration process, in certain aspects, the calibration process may be performed by the processor 270, executing the calibration module 276. The processor 270 may receive a plurality of states of a specific ground engaging member (e.g., the ground engaging member 125), where the plurality of states represents a full range of movement of that ground engaging member. For example, if the ground engaging member 125 can rotate 50° in both directions from center (i.e., facing straight forward), then, assuming the center state to be 0°, the plurality of states may range from −50° to 50°. Then, depending on the level of precision required for the calibration, the plurality of states may cover each degree of rotation (e.g., −50°, −49°, −48°, . . . , 48°, 49°, 50°) or cover a smaller increment of rotation (e.g., −50°, −49.5°, −49°, . . . , 49°, 49.5°, 50°). The specific ground engaging member may then be rotated through each of the plurality of states. As the specific ground engaging member is rotated through the plurality of states, one or more image capture devices may be used to capture images including a section of the ground engaging member. The one or more image capture devices may be image capture devices 120, 130, or some other image capture device that is positioned to capture images of the ground engaging member. But in order to minimize additional processing that may be needed to account for any differences between the position, orientation, and distortive effect of the image capture devices used to take the reference images and the image capture devices that are ultimately used during operation of the machine 110, it may be preferable to use the same image capture devices to take the reference images as the image capture devices 120, 130 that are ultimately used during operation of the machine 110. For each of the reference images, the processor 270 may associate the reference image with a particular state. For example, the processor 270 may include in the metadata for each reference image the particular state at which the ground engaging member depicted in that reference image is positioned. The processor 270 may know which state to associate with each reference image based on information provided by an operator or other external source. For instance, an operator uploading the reference images may indicate which state is to correspond with each reference image. Alternatively, the computing device may rely on information regarding the physical characteristics of the particular ground engaging member to organize the reference images, for example, from furthest turned to the left to furthest turned to the right, and assign each of them a state according to their displacement relative to the other reference images.

The processor 270 of the computing device 250, executing the projected path module 278, may determine a first projected path of travel of the machine 110 using the determined states of the ground engaging members 125, 135. The processor 270 may determine the first projected path using a mathematical model that incorporates as an input the current states of the ground engaging members 125, 135. For example, the processor 270 may predict the first projected path of the machine 110 by assuming that the ground engaging members of the machine 110 will travel in a circular path from their current states and calculating their trajectory using an angular displacement formula. According to certain aspects of the disclosure, such a calculation may take into account various factors such as the geometry of the ground engaging members, the speed of the machine 110, and any slipping that may be characteristic of the ground engaging members (e.g., a slip angle) given the speed of the machine 110, outside temperatures and weather conditions, axial length or wheel-based length, ground engaging member size or tract size, type of ground engaging member, articulation angle data, and other performance conditions. The processor 270 may assume that the body of the machine 110 would follow the same trajectory as the ground engaging members of the machine 110. Using information regarding the dimensions of the machine 110, the processor 270 then may estimate the first projected path of travel of the machine 110. While this method of determining the first projected path of travel of the machine 110 is described herein, one or ordinary skill in the art would appreciate that other methods of predicting the movement of a machine given certain parameters may also be used.

In certain aspects, the machine 110 may include a radar sensor (not depicted), which may be adjusted based on the projected path of travel of the machine 110 to detect objects within the path of travel.

In some aspects, the processor 270 may also deliver a measure of confidence (e.g., a confidence score) of its determination of the first projected path of travel of the machine 110. The measure of confidence may vary depending on factors including, for example, the proven accuracy of the calibration, the amount of time that is expected to pass before the machine 110 may reach a particular point in the projected path (assuming that the machine travels at a constant speed), ground and weather conditions that may affect the accuracy of the determination (e.g., having rain or snow on the ground that may increase the slip of the ground engaging member), and any assumptions that may have been made when determining the trajectory of the machine for the purposes of simplifying calculations.

The computing device 250 may generate a graphic (e.g., a set of lines) representing the first projected path of the machine 110 to overlay on the landscape image captured by the image capture device 170. In generating the graphic representing the first projected path, the computing device 250 may take into account any distortions or other optical aberrations that are present in the landscape image captured by the image capture device 170. The computing device 250 may also consider the position and orientation of the image capture device 170 and the location of the machine 110 relative to the area shown in the landscape image. The computing device 250 via I/O device 280 may transmit the image with the overlaid first projected path of the machine 110 to the display device 290. The display device 290 may then display the image and the first projected path of travel to an operator.

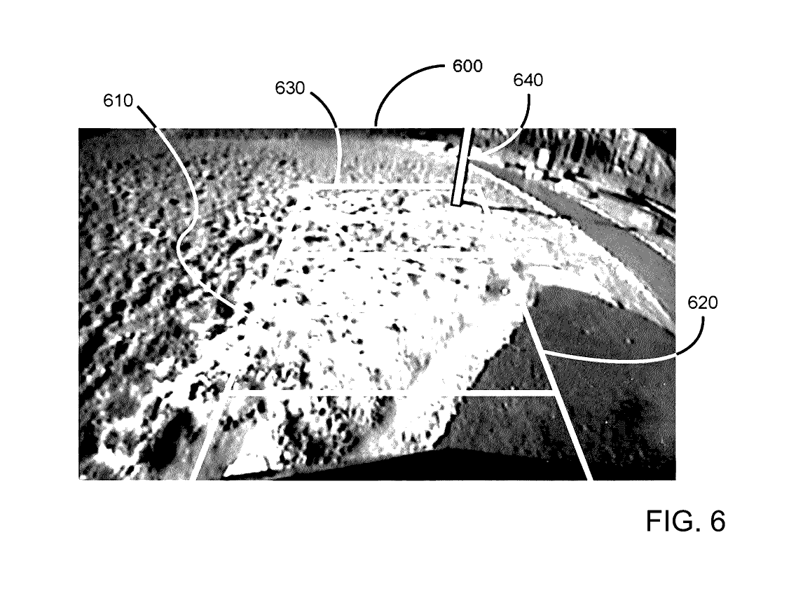

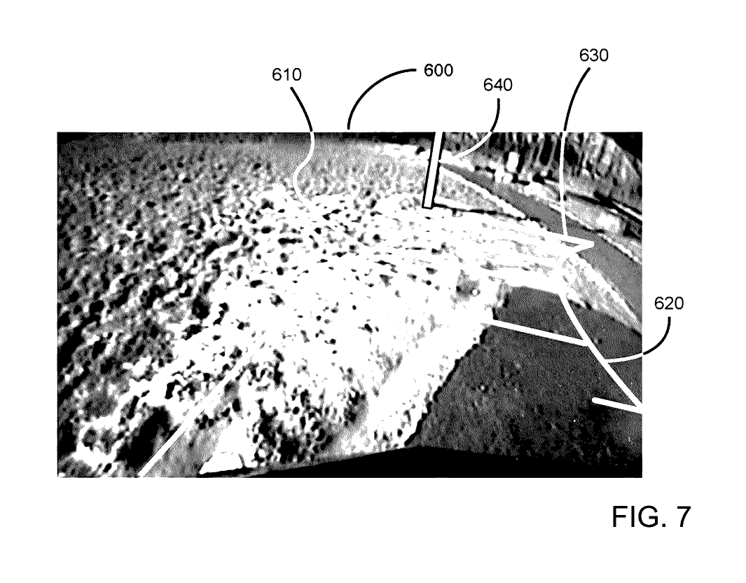

FIGS. 6 and 7 depict examples of displays including a landscape image and overlay lines representing a projected path of travel of a machine. In particular, FIGS. 6 and 7 depict a landscape image 600 showing a rearwards view of an area surrounding a machine such as the machine 110 with lines 610, 620, 630 marking the boundaries of a projected path of travel of the machine 110. FIG. 6 depicts the projected path of travel when the ground engaging members of the machine 110 are in a straight position (e.g., the first state depicted in FIG. 3); and FIG. 7 depicts the projected path of travel when the ground engaging members of the machine 110 are in an angled position (e.g., the second state depicted in FIG. 4). As the states of the ground engaging members of the machine 110 change (e.g., from a straight position to an angled position), the lines 610, 620, 630 showing the projected path of travel may update to reflect the new projected path of travel. In an aspect, the lines may update in real-time—that is, the lines representing the projected path of travel of the machine 110 may update each time the states of the ground engaging members change.

As depicted in FIGS. 6 and 7, the lines showing the projected path of travel of the machine 110 may only extend a certain distance into the area shown in the landscape image. In some aspects, the distance that such lines would extend may depend on the level of confidence of the determination of the projected path of travel. For example, assuming that the confidence of the accuracy of the projected path decreases as it extends further into the landscape image (perhaps because a farther distance would mean that a greater amount of time must pass before the machine 110 would reach that point in the projected path), there may come a point in the projected path where the confidence of the prediction is too low for the projected path to be of use to an operator. This may be programmed into the system by designating a threshold confidence level, below which the system would stop displaying the projected path of travel of the machine 110.

To increase the confidence of a given estimate for the path of travel, the system 200 may also rely on steering angle data captured by a steering wheel sensor. As noted above, the system 200 in addition to having image capture devices 120, 130, 170 may also have a steering wheel sensor 201. The steering wheel sensor 201 is configured to detect an angular position of the steering wheel. The interface 240 may receive analog signals from the steering wheel sensor 201 and convert them into digital signals which may be processed by the computing device 250. Specifically, the interface 240 may create steering angle data using information that it receives from the steering wheel sensor 201. The interface 240 may transmit the steering angle data to the computing device 250. The processor of the computing device 250, executing the state determining module 276, may then determine a second projected path of the machine 110 using the steering angle data. One method of determining the projected path may be to retrieve a bitmap depicting lines corresponding to the projected path that is associated with the steering angle that is detected. Bitmaps depicting projected paths of travel of the machine 110 for each steering angle value may be previously generated and stored in a memory (e.g., the memory 260). Then, when a steering angle value is received by the computing device 250, the processor 270 may reference the pre-stored bitmaps to retrieve the bitmap that is associated with the particular steering angle value that is received. A second method of determining the projected path may be through the use of a mathematical algorithm such as a Bezier curve equation which takes as an input the steering angle value or some parameter associated with the steering angle value.

Having determined a second projected path of travel of the machine 110, the computing device 250 may compare the first projected path of travel of the machine 110 to the second path of travel to identify any differences between the two paths. In one aspect, the computing device 250 may determine a third projected path of the machine 110 based on the differences between the two paths. For example, for each point on the first projected path that is different from its corresponding point on the second projected path, the computing device 250 may generate a new point representing a combination of the two points (e.g., a midway point between the two points). Using these new points and any points that were the same on both paths of travel of the machine 110, the computing device 250 may then generate a new path of travel of the machine 110 (e.g., a third projected path of travel). In another aspect, the computing device 250 may use the second projected path of travel to assess the confidence of its first projected path of travel. For example, where a portion of the second projected path of travel of the machine 110 differs by more than a predetermined amount from its corresponding portion in the first projected path of travel, the computing device may assign a low confidence score to that portion of the first projected path of travel. The display device 290 may then display that portion of the first projected path of travel in a different color (e.g., red) than the color of portions of the projected path that have a higher confidence score (e.g., green).

In certain aspects, different colors may also be used to show accuracy in calibration, proximity to an object, etc.

The many features and advantages of the disclosure are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

### INDUSTRIAL APPLICABILITY

The present disclosure is applicable to displaying a projected path of a mobile machine in general and to displaying a projected path of a machine at a location such as a construction site or mine site where there may be obstacles in the path of travel of the machine. Referring to FIG. 1, a machine 110 is depicted. The machine 110 may be a vehicle or any type of mobile equipment. While the machine 110 depicted in FIG. 1 is a wheel loader, those skilled in the art would understand that any type of work vehicle or equipment may be used. The machine 110 in FIG. 1 may include one or more image capture devices 120, 130, 140, 150, 160, 170 and sensors (e.g., the steering wheel sensor 201 depicted in FIG. 2) that may provide information to an onboard system, which uses such information to determine a projected path of travel for the wheel loader. The projected path of travel of the wheel loader may be displayed to an operator of the wheel loader to assist the operator in avoiding certain obstacles (e.g., the object 640 depicted in FIGS. 6 and 7) that may be in the path of travel of the wheel loader.

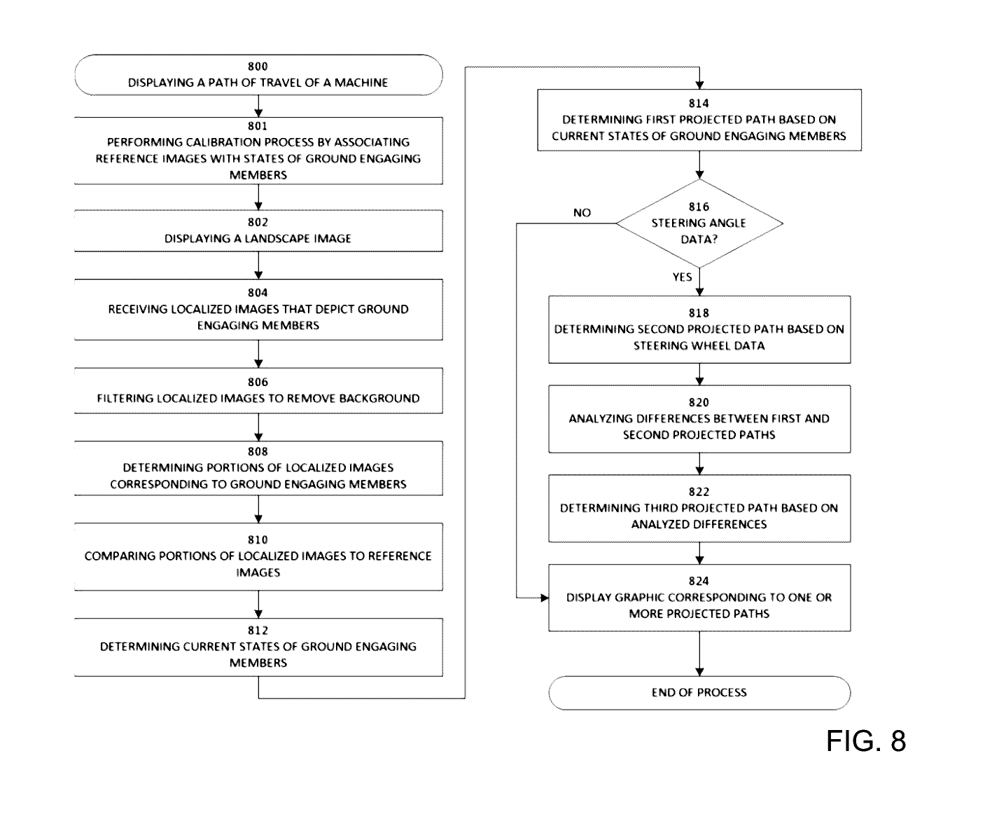

FIG. 8 illustrates a process flow chart for a method 800 for displaying a path of travel of a machine. For illustration, the operations of method 800 will be discussed in reference to one or more of FIGS. 1-7. At step 801, the system 200 may perform a calibration process. The processor 270 of the computing device 250, executing the calibration module 276, may perform the calibration process. The processor 270 may receive a plurality of states of a specific ground engaging member, for example, the ground engaging member 125. The plurality of states may be previously received and stored in the memory 260 of the computing device 250 or received from another server or processor. The plurality of states may include values that represent various positions of the ground engaging member in its full range of movement. For example, if the ground engaging member 125 can rotate 50° to its left and right, then, assuming its center position to be 0°, the plurality of states may range from −50° to 50° and may include a value for each of the degrees within the range (e.g., −50°, −49°, −48°, . . . , 48°, 49°, 50°). The processor 270 may then receive a plurality of reference images depicting a section of the ground engaging member in each of its states. For instance, if the plurality of states includes 101 states representing each degree of rotation (e.g., −50°, −49°, −48°, . . . , 48°, 49°, 50°), then the processor 270 may receive 101 reference images, each of which depicts a section of the ground engaging member in a different state. The plurality of reference images may be taken by an image capture device that is mounted on the machine 110 such as, for example, the image capture device 120, as the ground engaging member is rotated through its full range of motion. Similar to the plurality of states, the plurality of reference images may be previously received and stored in the memory 260 of the computing device 250 or may be captured at the time of calibration by an image capture device and transmitted to the computing device 250.

For each of the plurality of states, the processor 270 may associate it with the reference image that depicts the ground engaging member in that state. The processor 270 may have information that instructs it regarding which state to associate with each reference image. Such information may be previously stored in the memory 260 of the computing device 250, may be retrieved from another server or device, or may be manually entered by an operator at the time of performing the calibration. Alternatively, the processor 270 may rely on information regarding the physical characteristics of the ground engaging member to organize the reference images (e.g., from furthest turned to the left to furthest turned to the right) and associate each of them to a particular state.

At step 802, the system 200 via the display device 290, may display a landscape image. The landscape image may provide a view of the landscape or environment surrounding the machine 110. The landscape image may be captured by an image capture device that is mounted in a position that enables it to capture a large area surrounding the machine 110 such as, for example, the image capture devices 160, 170. The image capture device may incorporate a wide-angle lens in order to maximize the surrounding area that it captures. The landscape image may be captured in real-time when the machine 110 is in operation. Depending on the size of the display device 290, the landscape image may be adapted from its original size and formatted to fit on the display device 290.

At step 804, the system 200 via one or more image capture devices (e.g., image capture devices 120, 130, 140, 150) may capture one or more localized images that depict a section of one or more ground engaging members 125, 135, 145, 155 of the machine 110. The localized images, once captured by the image capture device(s) may be received by one or more interfaces 210, 220, 230. The interfaces 210, 220, 230 may convert the images into digital image data, which may be processed by the computing device 250. The interfaces 210, 220, 230 may then transmit the digital image data to the computing device 250. Similar to the landscape image, the localized images may be captured in real-time as the machine 110 is in operation.

At step 806, the computing device 250 of the system 200 may filter the localized images to remove a background or area that does not depict the one or more ground engaging members 125, 135, 145, 155 from the images. For example, each image may be deconstructed into multiple parts using edge detection techniques, and the parts that correspond to the background may be removed before the image is reconstructed.

At step 808, the computing device 250 may identify those portions of the localized images that depict the one or more ground engaging members 125, 135, 145, 155. The computing device 250 may identify those portions by using information regarding the ground engaging members 125, 135, 145, 155. The information regarding the ground engaging members 125, 135, 145, 155 may be previously stored in the memory 260 of the computing device 250 or may be accessible on a remote service or device. Such information may include information regarding the physical characteristics of the ground engaging members 125, 135, 145, 155 such as their color, tread patterns, markings, shape, etc. The computing device 250, relying on such information, may use color and pattern identification techniques to identify the portions of the images that depict the ground engaging members.

At step 810, the computing device 250 may compare the portions of the localized images depicting the one or more ground engaging members 125, 135, 145, 155 to a set of reference portions also depicting the one or more ground engaging members 125, 135, 145, 155. The set of reference portions may correspond to those portions of the reference images generated during the calibration process (step 801) which depict a section of one or more of the ground engaging members 125, 135, 145, 155. For each portion of a localized image that depicts a ground engaging member, the computing device 250 may compare that portion to a set of reference portions depicting the same ground engaging member. Thus, for example, if a portion of a localized image depicts a section of the ground engaging member 125, then the computing device 250 may compare that portion to a set of reference portions also depicting the ground engaging member 125. As described above, the set of reference portions may depict the ground engaging member 125 in a plurality of states that covers its full range of movement. Each reference portion may be associated with a particular state of the ground engaging member 125. From the comparison, the computing device 250 may identify a reference portion that matches the portion of the localized image depicting the ground engaging member 125. In step 812, the computing device 250 may then determine that the current state of the ground engaging member 125 is the particular state that is associated with the matching reference portion.

In certain aspects, when an exact match between a reference portion and the portion of the localized image being compared is not found, the computing device 250 may identify one or more reference images that are close matches to that portion and determine the current state of the ground engaging member by taking an average of the particular states associated with each of the one or more reference portions. For example, if two reference portions for a ground engaging member—one associated with a state of 10°, and one associated with a state of 11°—are close matches for a portion of a localized image depicting the ground engaging member, then the computing device 250 may determine the state of the ground engaging member to be 10.5°. Alternatively, the computing device 250 may also employ a different method of determining the state of the ground engaging member such as through analyzing one or more features of the ground engaging member.

In step 814, the computing device 250 may determine a first projected path of the machine 110 based on the determined states of the ground engaging members depicted in the localized images. The processor 270 may determine the first projected path using a mathematical model that incorporates as an input the current states of the ground engaging members or some parameter associated with the current states of the ground engaging members. The mathematical model may assume that the ground engaging members will move in a circular path from their current states and use one or more angular displacement equations to calculate the trajectory of the ground engaging members. Then, with information regarding the dimensions of the machine 110, and assuming that the machine 110 would follow the same trajectory as its ground engaging members (with necessary adjustments to account for possible differences between any trajectories of the ground engaging members), the computing device 250 may arrive at a projection for a first path of travel of the machine 110. While this method of determining the first projected path of travel of the machine 110 is described herein, one or ordinary skill in the art would appreciate that other methods may be used.

In step 816, the computing device 250 may query the system 200 to determine whether there is any steering angle data. If there is not steering angle data (step 816: NO), then the process may proceed to step 824, which is described in further detail below. If there is steering angle data (step 816: YES), then the process may proceed to step 818. In step 818, the computing device 250 may use the steering angle data to determine a second projected path of the machine 110. The steering angle data may come from information that is collected by the steering wheel sensor 201. The steering wheel sensor 201 is configured to detect an angular position of the steering wheel. The interface 240 may receive analog signals from the steering wheel sensor 201 and convert them into steering angle data, which it may subsequently transmit to the computing device 250. The computing device 250 may then determine a second projected path using the steering angle data, which may again be done through the use of a mathematical model.

In step 820, the computing device 250 may compare the first projected path of the machine 110 to the second projected path of the machine 110 to determine whether there are any differences between the two projected paths. If there are differences, then the computing device 250 may determine a third projected path of the machine 110 taking into account those differences (step 822). One way of taking into account of those differences may be to take an average of the two projected paths (i.e., to select a midway point between any point on the first path that may differ from its corresponding point on the second path).

In step 824, the computing device 250 may generate a graphic (e.g., a set of lines) representing the final projected path of the machine 110 (either the first projected path or a combination of the first projected path and the second projected path) to be overlaid on the landscape image. In generating the graphic representing the projected path, the computing device 250 may take into account any distortions or other optical aberrations that are present in the landscape image captured by the image capture device 170. The computing device 250 may also consider the position and orientation of the image capture device 170 and the location of the machine 110 relative to the area shown in the landscape image. The computing device 250 via I/O device 280 may transmit the graphic to the display device 290, which will display the graphic overlaying the landscape image. FIGS. 6 and 7 depict examples of displays including a landscape image 600 and an overlay graphic (e.g., lines 610, 620, 630) representing a projected path of travel of a machine.

As an illustrative example of the method 800 depicted in FIG. 8, a machine such as the wheel loader depicted in FIG. 1 may have two cameras (e.g., image capture devices) mounted near the front of the machine above its two front wheels (e.g., ground engaging members). Each camera may have a field of view including a section of a wheel and its surrounding terrain such as that shown in FIGS. 3, 4, and 5.

A system that displays a projected path of travel of the machine may be available to an operator of the machine. Before operation, the system may be calibrated by capturing images (e.g., reference images) of the front two wheels of the machine as they are rotated through their full range of movement. Each image captured during the calibration process may be associated with the degree of rotation of the wheel at the time the image is captured.

When the machine is in operation, the two cameras mounted on the machine may take images including sections of the two front wheels of the machine. The system may use the images captured by the two cameras to determine a current state or position of the front wheels. In particular, the system may process the images to isolate the portions of the images that depict the wheels. The system may compare the portions that depict the wheels to portions depicting the wheels in the set of calibration images. If a match is found between a portion depicting the wheels in operation and a portion depicting the wheels in the set of calibration images, then the system may determine that the current state of a wheel is the state of the wheel that is associated with the calibration image including the matching portion.

Using the current states of the wheels that it determines, the system may calculate a projected path of the machine. The calculation may be based on conventional angular displacement principles and may take into account various physical properties of the wheels, the dimensions of the wheels and the machine, and other factors that may affect the movement of the machine (e.g., surface conditions, weather, temperature).

The system may display on a display device a graphic representing the projected path of the machine to the operator. The graphic may be displayed overlaying an image depicting an area surrounding the machine in its direction of travel. The machine may have an additional camera mounted in a location that enables it to capture this area surrounding the machine. For example, the machine may have a camera mounted on top of its frame facing rearwards. When the machine is travelling in a rearwards direction, this additional camera may then capture images showing an area to the back of the machine.

By displaying the projected path of travel of the machine, the system may assist an operator in avoiding certain obstacles near the machine. For example, in FIGS. 6 and 7, an object 640 is located near the rear of a machine. The operator, viewing the display in FIG. 6, may see that the current path of travel of the machine may lead to a collision with the object 640. Thus, to avoid the object, the operator may adjust the position of the ground engaging members of the machine so that the projected path of travel of the machine may avoid the object 640 (see FIG. 7).

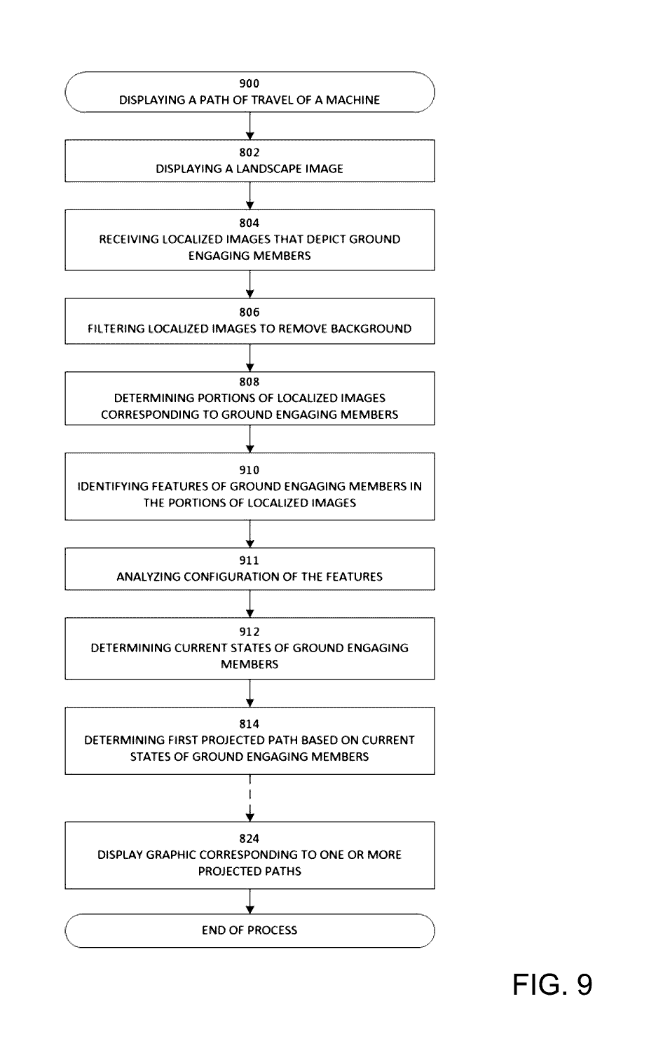

Referring now to FIG. 9, FIG. 9 depicts a process flow chart for a method 900 for displaying a path of travel of a machine. The method 900 may share many of the same steps as the method 800 depicted in FIG. 8. In step 802, the system 200 via the display device 290 may display the landscape image. In step 804, the system 200 may receive the localized images that depict sections or one or more ground engaging members. In step 806, the system 200 may filter the localized images to remove the background from the images. And, in step 808, the system 200 may identify portions of the localized images that depict the ground engaging members.

In step 910, the computing device 250 of the system 200 may identify features of the ground engaging members in the one or more portions of the localized images. Features of a ground engaging member may include an applied marking such as an embossment of a symbol, text, or numerical value, a paint marker, a tread pattern, or other visible feature associated with the ground engaging member. The computing device 250 may receive (or retrieve) information regarding the physical characteristics of the ground engaging members. Such information may be previously stored on the computing device 250 or may be received from another server or processor. Using that information, the computing device 250 may identify one or more features of the ground engaging members depicted in the localized images. For example, as depicted in FIGS. 3, 4, and 5, a ground engaging member 310 may have a tread mark 320. The computing device 250, knowing the physical characteristics of the ground engaging member 310, may identify the tread mark 320 as a feature of the ground engaging member 310.

In steps 911 and 912, the computing device 250 may analyze the configuration or orientation of the identified features to determine the current state of the ground engaging members. The orientation of the features may change as the states of the ground engaging members change. For example, as depicted in FIGS. 3, 4, and 5, as the state of the ground engaging member 310 changes, the orientation of the tread mark 320 changes. Thus, by analyzing a feature such as the tread mark 320 and determining its orientation, the computing device 250 may be able to discern a current state of a ground engaging member.

In step 814, the computing device 250 may determine a first projected path of the machine 110 based on the current states of the ground engaging members. And in step 824, the computing device 250 may generate a graphic (e.g., a set of lines) representing the projected path of the machine 110 to be overlaid on the landscape image. Although not depicted in FIG. 9, the method 900 may also include steps 816 through 822, as depicted in FIG. 8.

Whether such functionality is implemented as hardware or software depends upon the design constraints imposed on the overall system. Skilled persons may implement the described functionality in varying ways for each particular application, but such implementation decisions should not be interpreted as causing a departure from the scope of the disclosure. In addition, the grouping of functions within a module, block, or step is for ease of description. Specific functions or steps may be moved from one module or block without departing from the disclosure.

The various illustrative logical blocks and modules described in connection with the aspects disclosed herein may be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor (e.g., of a computer), or in a combination of the two. A software module may reside, for example, in RAM memory, flash memory, ROM memory, EPROM memory, EEPROM memory, registers, hard disk, a removable disk, a CD-ROM, or any other form of storage medium. An exemplary storage medium may be coupled to the processor such that the processor may read information from, and write information to, the storage medium. In the alternative, the storage medium may be integral to the processor. The processor and the storage medium may reside in an ASIC.

In at least some aspects, a processing system (e.g., the computing device 250) that implements a portion or all of one or more of the technologies described herein may include a general-purpose computer system that includes or is configured to access one or more computer-accessible media.

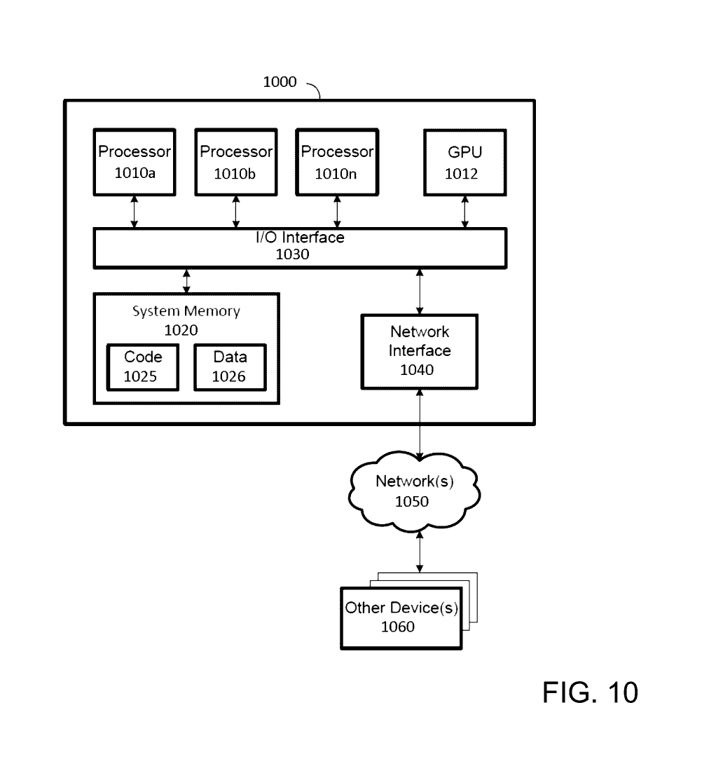

FIG. 10 depicts a general-purpose computer system that includes or is configured to access one or more computer-accessible media. In the illustrated aspect, a computing device 1000 may include one or more processors 1010a, 1010b, and/or 1010n (which may be referred herein singularly as the processor 1010 or in the plural as the processors 1010) coupled to a system memory 1020 via an I/O interface 1030. The computing device 1000 may further include a network interface 1040 coupled to an I/O interface 1030. The computing device 1000 may correspond to the computing device 250, described above.

In various aspects, the computing device 1000 may be a uniprocessor system including one processor 1010 or a multiprocessor system including several processors 1010 (e.g., two, four, eight, or another suitable number). The processors 1010 may be any suitable processors capable of executing instructions. For example, in various aspects, the processor(s) 1010 may be general-purpose or embedded processors implementing any of a variety of instruction set architectures (ISAs), such as the x86, PowerPC, SPARC, or MIPS ISAs, or any other suitable ISA. In multiprocessor systems, each of the processors 1010 may commonly, but not necessarily, implement the same ISA.

In some aspects, a graphics processing unit (GPU) 1012 may participate in providing graphics rendering and/or physics processing capabilities. A GPU may, for example, include a highly parallelized processor architecture specialized for graphical computations. In some aspects, the processors 1010 and the GPU 1012 may be implemented as one or more of the same type of device.

The system memory 1020 may be configured to store instructions and data accessible by the processor(s) 1010. In various aspects, the system memory 1020 may be implemented using any suitable memory technology, such as static random access memory (SRAM), synchronous dynamic RAM (SDRAM), nonvolatile/Flash®-type memory, or any other type of memory. In the illustrated aspect, program instructions and data implementing one or more desired functions, such as those methods, techniques and data described above, are shown stored within the system memory 1020 as code 1025 and data 1026.

In one aspect, the I/O interface 1030 may be configured to coordinate I/O traffic between the processor(s) 1010, the system memory 1020 and any peripherals in the device, including a network interface 1040 or other peripheral interfaces. In some aspects, the I/O interface 1030 may perform any necessary protocol, timing or other data transformations to convert data signals from one component (e.g., the system memory 1020) into a format suitable for use by another component (e.g., the processor 1010). In some aspects, the I/O interface 1030 may include support for devices attached through various types of peripheral buses, such as a variant of the Peripheral Component Interconnect (PCI) bus standard or the Universal Serial Bus (USB) standard, for example. In some aspects, the function of the I/O interface 1030 may be split into two or more separate components, such as a north bridge and a south bridge, for example. Also, in some aspects some or all of the functionality of the I/O interface 1030, such as an interface to the system memory 1020, may be incorporated directly into the processor 1010.

The network interface 1040 may be configured to allow data to be exchanged between the computing device 1000 and other device or devices 1060 attached to a network or networks 1050, such as other computer systems or devices, for example. In various aspects, the network interface 1040 may support communication via any suitable wired or wireless general data networks, such as types of Ethernet networks, for example. Additionally, the network interface 1040 may support communication via telecommunications/telephony networks, such as analog voice networks or digital fiber communications networks, via storage area networks, such as Fibre Channel SANs (storage area networks), or via any other suitable type of network and/or protocol.

In some aspects, the system memory 1020 may be one aspect of a computer-accessible medium configured to store program instructions and data as described above for implementing aspects of the corresponding methods and apparatus. However, in other aspects, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to computing device the 1000 via the I/O interface 1030. A non-transitory computer-accessible storage medium may also include any volatile or non-volatile media, such as RAM (e.g., SDRAM, DDR SDRAM, RDRAM, SRAM, etc.), ROM, etc., that may be included in some aspects of the computing device 1000 as the system memory 1020 or another type of memory. Further, a computer-accessible medium may include transmission media or signals, such as electrical, electromagnetic or digital signals, conveyed via a communication medium, such as a network and/or a wireless link, such as those that may be implemented via the network interface 1040. Portions or all of multiple computing devices, such as those illustrated in FIG. 10, may be used to implement the described functionality in various aspects; for example, software components running on a variety of different devices and servers may collaborate to provide the functionality. In some aspects, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

It should also be appreciated that the systems in the figures are merely illustrative and that other implementations might be used. Additionally, it should be appreciated that the functionality disclosed herein might be implemented in software, hardware, or a combination of software and hardware. Other implementations should be apparent to those skilled in the art. It should also be appreciated that a server, gateway, or other computing node may include any combination of hardware or software that may interact and perform the described types of functionality, including without limitation desktop or other computers, database servers, network storage devices and other network devices, PDAs, tablets, cellphones, wireless phones, pagers, electronic organizers, Internet appliances, and various other consumer products that include appropriate communication capabilities. In addition, the functionality provided by the illustrated modules may in some aspects be combined in fewer modules or distributed in additional modules. Similarly, in some aspects the functionality of some of the illustrated modules may not be provided and/or other additional functionality may be available.

Each of the operations, processes, methods, and algorithms described in the preceding sections may be embodied in, and fully or partially automated by, code modules executed by at least one computer or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The exemplary blocks or states may be performed in serial, in parallel, or in some other manner. Blocks or states may be added to or removed from the disclosed example aspects. The exemplary systems and components described herein may be configured differently than described. For example, elements may be added to, removed from, or rearranged compared to the disclosed example aspects.

We claim:

1. A method for displaying a path of travel of a machine, comprising:
receiving from a first image capture device a landscape image;
displaying on a display device the landscape image;
receiving one or more localized images from one or more additional image capture devices, each of the one or more localized images depicting a section of one or more ground engaging members of the machine;
determining one or more portions of the one or more localized images that correspond to the one or more ground engaging members;
analyzing the one or more portions to determine a current state of each of the one or more ground engaging members;
determining a first projected path of the machine based on at least the current state of each of the one or more ground engaging members; and
displaying on the display device a graphic corresponding to the first projected path of the machine, the graphic displayed overlaying the landscape image.

2. The method of claim 1, wherein at least one of the one or more additional image capture devices is a digital camera including a wide-angle lens.

3. The method of claim 1, wherein analyzing the one or more portions to determine a current state of each of the one or more ground engaging members comprises:
comparing a first portion of the one or more portions to a set of reference portions to identify a second portion of the set of reference portions that matches the first portion, each of the set of reference portions depicting the same ground engaging member as the first portion and associated with a state of the ground engaging member; and
determining the current state of the ground engaging member depicted in the first portion based on at least the respective state associated with the second portion.

4. The method of claim 1, wherein analyzing the one or more portions to determine a current state of each of the one or more ground engaging members comprises:
identifying one or more features of a specific ground engaging member in the one or more portions;
analyzing a configuration of the one or more features; and
determining the current state of the specific ground engaging member based on at least the analyzing the configuration of the one or more features.

5. The method of claim 4, wherein the one or more features comprises one or more of a tread and an applied marking.

6. The method of claim 1, further comprising:
receiving a plurality of states of a specific ground engaging member, the plurality of states representing a range of movement of the specific ground engaging member;
capturing, using the one or more additional image capture devices, a plurality of reference images for the specific ground engaging member;
determining, for each of the plurality of states, a reference image of the plurality of reference images that depicts the specific ground engaging member in the respective state; and
associating, for each of the plurality of states, the determined reference image with the respective state.

7. The method of claim 1, further comprising:
determining a steering wheel angle of the machine; and
retrieving information regarding the machine and the one or more ground engaging members;
determining a second projected path of the machine based on the steering wheel angle and the retrieved information;
analyzing differences between the first projected path and the second projected path of the machine; and
determining a third projected path of the machine based on the analyzed differences.

8. The method of claim 1, wherein identifying the one or more portions of the one or more localized images that correspond to the one or more ground engaging members comprises filtering each localized image to remove a background of the localized image.

9. A method for displaying a path of travel of a machine, comprising:
receiving one or more images from one or more image capture devices, the one or more image capture devices disposed on the machine;
displaying on a display device a first image of the one or more images;
determining one or more ground engaging members of the machine in the one or more images;
determining a current state of each of the one or more ground engaging members using at least information regarding the one or more ground engaging members contained in the one or more images;
determining a first projected path of the machine based on the current state of each of the one or more ground engaging members; and
displaying on the display device a graphic corresponding to the first projected path of the machine, the graphic displayed overlaying the first image.

10. The method of claim 9, wherein at least one of the one or more image capture devices is a digital camera including a wide-angle lens.

11. The method of claim 9, wherein determining the current state of each of the one or more ground engaging members comprises:
determining a first portion of an image of the one or more images that depicts a ground engaging member;
comparing the image including the first portion to a set of reference images to identify a reference image that includes a second portion that matches the first portion, each of the set of reference images depicting the same ground engaging member as the first portion and associated with a state of the ground engaging member; and
determining the current state of the ground engaging member depicted in the first portion based on at least the respective state associated with the reference image.

12. The method of claim 9, wherein determining the current state of each of the one or more ground engaging members comprises:
identifying one or more features of a specific ground engaging member in the one or more images;
analyzing a configuration of the one or more features; and
determining the current state of the specific ground engaging member based on at least the analyzing the configuration of the one or more features.

13. The method of claim 12, wherein the one or more features comprises one or more of a tread and an applied marking.

14. The method of claim 9, further comprising:
receiving a plurality of states of a specific ground engaging member, the plurality of states representing a range of movement of the specific ground engaging member;
capturing using the one or more image capture devices a plurality of reference images for the specific ground engaging member;
determining, for each of the plurality of states, a reference image of the plurality of reference images that depicts the specific ground engaging member in the respective state; and
associating, for each of the plurality of states, the determined reference image with the respective state.

15. The method of claim 9, further comprising:
determining a steering wheel angle of the machine; and
retrieving information regarding the machine and the one or more ground engaging members,
determining a second projected path of the machine based on the steering wheel angle and the retrieved information;
analyzing differences between the first projected path and the second projected path of the machine; and
determining a third projected path of the machine based on the analyzed differences.

16. A system for displaying a path of travel of a machine comprising:
a processor; and
a memory bearing instructions that, upon execution by the processor, cause the system at least to:
receive one or more images from one or more image capture devices, the one or more image capture devices disposed on the machine;
display on a display device a first image of the one or more images;
determine one or more ground engaging members of the machine in the one or more images;
determine a current state of each of the one or more ground engaging members using at least information regarding the one or more ground engaging members contained in the one or more images;
determine a first projected path of the machine based on at least the current state of each of the one or more ground engaging members; and
display on the display device a graphic corresponding to the first projected path of the machine, the graphic displayed overlaying the first image.

17. The system of claim 16, wherein determining the current state of each of the one or more ground engaging members comprises:
determining a first portion of an image of the one or more images that depicts a ground engaging member;
comparing the image including the first portion to a set of reference images to identify a reference image that includes a second portion that matches the first portion, each of the set of reference images depicting the same ground engaging member as the first portion and associated with a state of the ground engaging member; and
determining the current state of the ground engaging member depicted in the first portion based on at least the respective state associated with the reference image.

18. The system of claim 16, wherein determining the current state of each of the one or more ground engaging members comprises:
identifying one or more features of a specific ground engaging member in the one or more images;
analyzing a configuration of the one or more features; and
determining the current state of the specific ground engaging member based on at least the analyzing the configuration of the one or more features.

19. The system of claim 18, wherein the one or more features comprises one or more of a tread and an applied marking.

20. The system of claim 16, wherein the instructions that, upon execution by the processor, further cause the system to:
receive a plurality of states of a specific ground engaging member, the plurality of states representing a range of movement of the specific ground engaging member;
capture using the one or more image capture devices a plurality of reference images for the specific ground engaging member;
determine, for each of the plurality of states, a reference image of the plurality of reference images that depicts the specific ground engaging member in the respective state; and
associate, for each of the plurality of states, the determined reference image with the respective state.
